(19) United States
(12) Patent Application Publication
(10) Pub. No.: US 2005/0265423 A1
(43) Pub. Date: Dec. 1, 2005

(54) Monitoring system for cooking station

(76) Inventors: Peter H. Mahowald, Los Altos, CA (US); Mark Arthur Kriss, La Selva Beach, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/854,464

(22) Filed: May 26, 2004

(51) Int. Cl. G01J 5/00

(52) U.S. Cl. 374/121

(57) ABSTRACT

A monitoring system comprising an image sensor adapted to provide image signals of a cooking station, and a control circuit. The control circuit is configured to receive the image signals and process the image signals to determine at least one state of the cooking station.

### BACKGROUND

Fires take thousands of lives and cause billions of dollars in damage each year. Within minutes of bursting into flames, a fire may consume the contents, walls and ceiling of the room where the fire started. Also, the combination of heat and carbon monoxide can kill everyone in the area. Studies cite that in the United States about 80 percent of all fire deaths occur in the home and about 70 percent of all building structure fires occur in the home. More fires start in the kitchen than in any other room in the house.

In homes, cooking is one of the leading causes of fires and fire related injuries. Cooking fires often result from unattended cooking and human error, rather than mechanical failure of cooking devices, such as stoves, conventional ovens, microwave ovens and barbecues. In commercial eating establishments, fires from cooking devices can be devastating, often causing cessation of normal business activities for days or weeks, and sometimes permanently. Due to the nature of cooking, the threat of a fire is always present. Having the means to prevent and/or detect a fire in and around a cooking device before the fire has a chance to spread is essential to saving lives and limiting damage.

Smoke detectors are often used to detect fires. However, smoke detectors typically operate to detect particulates in the air. Such particulates may arise from smoke due to fire, but can also arise from a variety of other sources including water vapor, steam and cooking fumes. Accordingly, a smoke detector in a kitchen or cooking area is susceptible to providing false alarms. These false alarms can be bothersome and lead to someone permanently disabling the smoke alarm in the cooking area or not placing the smoke alarm in the cooking area. The smoke alarm can be placed in another room. However, fires may not be detected in time to prevent widespread damage and loss of life.

Fire safety equipment, including sprinkler systems, often includes some type of fusible link. When the fusible link gets sufficiently hot, it melts and thereby activates fire alarms and fire suppression equipment. However, the fire may need to be quite large to melt the fusible link and a substantial amount of damage can be incurred before the fire is extinguished.

For these and other reasons there is a need for the present invention.

### SUMMARY

One aspect of the present invention provides a monitoring system comprising an image sensor adapted to provide image signals of a cooking station, and a control circuit. The control circuit is configured to receive the image signals and process the image signals to determine at least one state of the cooking station.

### BRIEF DESCRIPTION OF THE DRAWINGS

FIG. 1 is a diagram illustrating one embodiment of a monitoring system and a cooking station.

FIG. 2 is a diagram illustrating one embodiment of a monitoring system.

FIG. 3 is a diagram illustrating a filter arrangement in one embodiment of an image sensor.

FIG. 4 is a diagram illustrating one embodiment of a monitoring system.

FIG. 5 is a diagram illustrating one embodiment of a multiple station monitoring system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

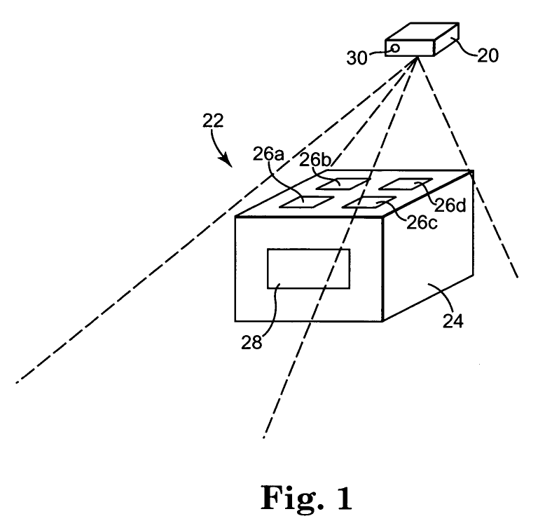

FIG. 1 is a diagram illustrating one embodiment of a monitoring system 20 and a cooking station, indicated at 22. Monitoring system 20 monitors an area, indicated in dashed lines, that includes cooking station 22. Cooking station 22 includes cooking device 24 and the area that is used by a person attending to cooking with cooking device 24.

In one embodiment, monitoring system 20 monitors cooking station 22, which includes an approach that leads up to cooking device 24, such as the area in front of cooking device 24. In one embodiment, monitoring system 20 monitors cooking station 22, which includes an area above cooking device 24, such as the area located between monitoring system 20 and cooking device 24. In other embodiments, monitoring system 20 monitors a cooking station, which includes any suitable area used by a person to attend to cooking with a cooking device, such as one or more sides of the cooking device.

Cooking device 24 includes range top heating areas 26a-26d and an oven 28. Each of the heating areas 26a-26d includes a heating element that can be any suitable type of heating element, such as a natural gas heating element or an electrical heating element. Also, oven 28 includes any suitable type of heating element, such as natural gas and/or electrical heating elements, and any suitable number of heating elements, such as one heating element for baking and one heating element for broiling.

Monitoring system 20 can monitor any suitable cooking device, such as a stove, an oven, a barbecue, or a microwave oven. Also, monitoring system 20 can monitor one or more small appliance cooking devices, such as one or more waffle irons, electric skillets, and rice cookers. These small appliances can be positioned on any suitable platform, such as other cooking devices, countertops and/or tables. Also, a monitored cooking device can include any suitable number of heating areas, such as one range top heating area, one oven, a barbecue area, or a plurality of range top heating areas and an oven with a small appliance positioned on the cooking device. In addition, a monitored cooking device can be situated in any suitable location, such as a commercial eating establishment or a residence.

In one embodiment, monitoring system 20 monitors a portion of a suitable cooking device. In this embodiment, the suitable cooking device is divided into a plurality of cooking stations. Each of the plurality of cooking stations is monitored by a separate monitoring system 20. In an example commercial eating establishment, an example cooking device, such as a grill or a barbecue, can be divided into a plurality of cooking stations, with each cooking station monitored by a different monitoring system 20.

Monitoring system 20 can be positioned at any suitable location to monitor one or more cooking stations, such as cooking station 22. Suitable locations include under the hood of a stove, on the ceiling of a kitchen, and on a wall or the ceiling of a room containing one or more cooking devices.

Monitoring system 20 provides and processes image signals of cooking station 22. Monitoring system 20 provides image signals of each of the heating areas 26a-26d and oven 28. Monitoring system 20 also provides image signals of people attending to cooking station 22 and pans on heating areas 26a-26d of cooking device 24. Monitoring system 20 processes the image signals to determine states of cooking station 22.

In one embodiment, states of cooking station 22 include the on/off state of each heating area 26a-26d and oven 28 of cooking station 22. In one embodiment, states of cooking station 22 include one of a plurality of heating levels associated with each heating area 26a-26d and oven 28. In one embodiment, states of cooking station 22 include whether cooking station 22 has been attended by a person within a predetermined period of time or left unattended for the predetermined period of time. In one embodiment, states of cooking station 22 include whether a pan is present or absent from each of the heating areas 26a-26d. In one embodiment, states of cooking station 22 include the presence or absence of food in a pan on cooking station 22. In one embodiment, states of cooking station 22 include whether a fire is present at cooking station 22. In one embodiment, states of cooking station 22 include an intermediate level of fire protection that indicates an intermediate level fire is present at cooking station 22. The intermediate level fire is not large enough to warrant an immediate fire alarm.

Monitoring system 20 provides alarm signals that correspond to a state or combination of states of cooking station 22. In one embodiment, monitoring system 20 provides an alarm signal that indicates a fire has started at cooking station 22. The fire alarm is a high priority alarm signal that takes precedence over other alarm conditions. In one embodiment, monitoring system 20 provides an intermediate level fire alarm signal that indicates an intermediate level fire is present at cooking station 22. The intermediate level fire is not large enough to warrant an immediate fire alarm. The intermediate level fire alarm signal gives the user time to react to a possible fire condition before the fire alarm is set off. This allows for moving a pan to one side of a burner, flambéing or other open flame cooking. In one embodiment, monitoring system 20 includes a button or switch 30 that is pressed to disable monitoring system 20, which allows for flambéing or other open flame cooking without setting off the fire alarm.

In one embodiment, monitoring system 20 provides an alarm signal that indicates at least one of the heating areas 26a-26d and/or oven 28 is on and cooking station 22 has been left unattended for the predetermined period of time. Monitoring system 20 provides the alarm signal whether a pan is present or absent from cooking station 22. The on and unattended alarm signal is used to draw attention to cooking station 22 and help prevent fires. In one embodiment, monitoring system 20 turns off cooking station 22 in response to the on and unattended alarm signal.

In one embodiment, monitoring system 20 provides an alarm signal that indicates the presence of a pan on at least one of the heating areas 26a-26d, while the at least one heating area 26a-26d is on and unattended. This alarm signal is used to draw attention to cooking station 22 and help prevent food from burning and help prevent fires. In one embodiment, monitoring system 20 turns down the at least one heating area 26a-26d in response to the alarm signal.

In one embodiment, monitoring system 20 provides an alarm signal that indicates the absence of food in a pan that is present on one of the heating areas 26a-26d, while the heating area 26a-26d is off and unattended. This alarm signal can be especially helpful for people who forget to put food in a pan for eating.

In one embodiment, monitoring system 20 provides an alarm signal that indicates the presence of a pan on one of the heating areas 26a-26d, while the heating area 26a-26d is off and unattended. This alarm signal can be especially helpful for people who forget to turn on the heat for cooking.

In one embodiment, monitoring system 20 provides an alarm signal that indicates the presence of a pan on one of the heating areas 26a-26d, while cooking station 22 has been left unattended. The pan on and unattended alarm signal is provided whether all of the heating areas 26a-26d are off or at least one of the heating areas 26a-26d is on. The pan on and unattended alarm signal is helpful for people who forget to attend to a pan on cooking device 24. In other embodiments, monitoring system 20 provides an alarm signal to indicate any suitable state or combination of states of cooking station 22.

Monitoring system 20 provides alarm signals and attempts to notify people of the state or combination of states of cooking station 22. Monitoring system 20 provides a response to each of the alarm signals based on the state or combination of states that brought about the alarm signal. In one embodiment, monitoring system 20 provides an audible alarm that is at least part of a response to each alarm signal. The audible alarm can be any suitable audible alarm, such as a chirp, a tone, a buzzer or a voice alarm that provides a spoken message. In one embodiment, monitoring system 20 provides an audible fire alarm in response to the fire alarm signal. The audible fire alarm includes a voice alarm, which tells people a fire has been detected and to evacuate the building. In one embodiment, monitoring system 20 provides an audible alarm, such as a series of chirps, in response to the intermediate level fire alarm signal. In one embodiment, monitoring system 20 provides an audible alarm, such as a series of chirps and a voice alarm, in response to the intermediate level fire alarm signal. The voice alarm includes a message, which tells people an intermediate level fire has been detected at the monitored cooking station and the fire alarm will sound if the fire is not attended to or persists.

In one embodiment, monitoring system 20 communicates with cooking device 24 to regulate heating areas 26a-26d and oven 28 of cooking device 24. In one embodiment, monitoring system 20 turns off all cooking areas 26a-26d and oven 28 in response to the fire alarm signal. An audible fire alarm is also provided to notify people in the area of the fire. In one embodiment, monitoring system 20 turns off all cooking areas 26a-26d and oven 28 and provides an audible alarm in response to the on and unattended alarm signal. In one embodiment, monitoring system 20 turns at least one of the heating areas 26a-26d to a lower heating level and provides an audible alarm in response to an alarm signal that indicates the presence of a pan on one of the heating areas 26a-26d, while the heating area 26a-26d is on and unattended.

In one embodiment, monitoring system 20 communicates with at least one external source to notify people of the state or a combination of states of cooking station 22. Monitoring system 20 communicates with external sources, such as a home automation system, a security system, the fire department, the world wide web, and cooking device 24. The home automation system and the security system may communicate with the fire department, the world wide web and cooking device 24. The cooking device 24 can include a display that provides a suitable response, such as describing the alarm or providing a flashing light to draw attention to cooking station 22. In one embodiment, monitoring system 20 communicates with an external source via a wired connection. In one embodiment, monitoring system 20 communicates with an external source wirelessly.

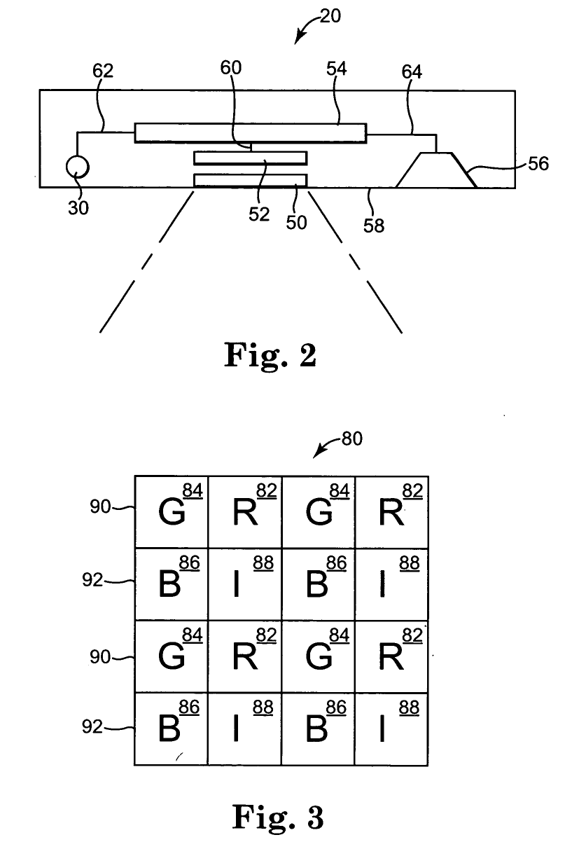

FIG. 2 is a diagram illustrating one embodiment of monitoring system 20. The monitoring system 20 includes a lens 50, an image sensor 52, a control circuit 54, switch 30, a speaker 56, and an enclosure 58. Image sensor 52 is electrically coupled to control circuit 54 via conductive path 60. Control circuit 54 is electrically coupled to switch 30 via switch conductive path 62, and to speaker 56 via speaker conductive path 64. In one embodiment, image sensor 52 includes multiple image sensors. In one embodiment, control circuit 54 includes multiple signal processing chips, such as in a chip set family.

Lens 50 is mounted to enclosure 58 and positioned to focus electromagnetic waves, such as visible and infrared light, on image sensor 52. Lens 50 focuses the electromagnetic waves from a cooking station, such as cooking station 22 (shown in FIG. 1), on to image sensor 52. In one embodiment, lens 50 is a short focal length lens that provides a wide angle view of a subject area. The view from the short focal length lens includes more of the subject area than the view from a normal focal length lens.

In one embodiment, lens 50 is protected from dirt and grease to provide a clear image of a viewed cooking station, such as cooking station 22. In one such embodiment, a cone shield is situated on lens 50 with the small portion of the cone adjacent lens 50 and the wide portion of the cone directed toward the viewed cooking station. The cone shield restricts air circulation near lens 50. Since grease and dirt are heavier than air, the grease and dirt tend to fall away and stay away from lens 50.

In one embodiment, a screen is placed over lens 50 to keep grease and dirt away from lens 50. The screen is out of focus to lens 50 and image sensor 52. As the screen collects grease and dirt the contrast of the image is lowered and compensated for, however, the clarity remains essentially unchanged.

In one embodiment, lens 50 is treated with a substance to prevent the build-up of grease and dirt. The substance can be averse to collecting grease and dirt and/or make lens 50 self cleaning. In other embodiments, other suitable methods can be used to keep lens 50 clean, such as electrostatic potentials situated around lens 50 and combinations of the above described embodiments.

Image sensor 52 provides image signals of cooking station 22 to control circuit 54. Image sensor 52 is responsive to electromagnetic waves in the visual and infrared light spectrum. In one embodiment, image sensor 52 and control circuit 54 are part of a single integrated circuit chip. In one embodiment, image sensor 52 is provided in one integrated circuit chip and control circuit 54 is provided in another one or more integrated circuit chips.

Image sensor 52 provides image signals of cooking station 22 including each of the heating areas 26a-26d (shown in FIG. 1). In the off state, each of the heating areas 26a-26d appears dark in the infrared light spectrum. A heating area 26a-26d that is on appears bright in the infrared light spectrum. In one embodiment, heating areas 26a-26d that are off appear dark in the infrared light spectrum and heating areas 26a-26d that are on include one or more bright circular rings with dark spots in the middle.

Detecting whether oven 28 (shown in FIG. 1) is on includes imaging heat in the infrared light spectrum rising from the front of cooking device 24 (shown in FIG. 1). The front appears dark when oven 28 is off and bright in the infrared light spectrum when oven 28 is on. When heat is detected outside of heating areas 26a-26d and the front of heating device 24, control circuit 54 provides the fire alarm signal to indicate a fire has started. Also, the heating level of each of the heating areas 26a-26d and oven 28 is determined by the brightness of the image in the infrared light spectrum. Control circuit 54 assigns an associated heating level to each of the heating areas 26a-26d and oven 28.

A pan is imaged in the visual and infrared light spectrums. An image in the visual light spectrum identifies a pan placed on a heating area 26a-26d that is off. An image in the visual light spectrum and infrared light spectrum identifies a pan present on a heating area 26a-26 that is on. A pan placed on a heating area 26a-26d that is on causes the dark spot in the middle to go away, presents a more uniform heating pattern and lowers the heating level. The presence of a person can be detected with image sensor 52 in the visual and infrared light spectrums, and food can be detected in the visual light spectrum.

Image sensor 52 and control circuit 54 create an image of cooking station 22. In one embodiment, image sensor 52 and control circuit 54 create a digital image of cooking station 22. The digital image of cooking station 22 includes a matrix of pixels, which are the smallest elements in the digital image. Each pixel contains electromagnetic wavelength and brightness information about the viewed image.

In one embodiment, image sensor 52 is a solid-state image sensor containing a photosite for each pixel in the image. Each photosite corresponds to one pixel and is a small area in image sensor 52 that captures the brightness of the electromagnetic wave that strikes it during an exposure. In one embodiment, image sensor 52 includes filters situated between lens 50 and the photosites of image sensor 52. A filter is placed over each photosite to differentiate between different electromagnetic wavelengths. In one embodiment, image sensor 52 includes red filters, green filters, blue filters and infrared filters. Each photosite has one filter over it, such as a red filter, a green filter, a blue filter, or an infrared filter. In one embodiment, image sensor 52 includes redish/orange filters, bluish/green filters and infrared filters. In one embodiment, image sensor 52 does not include any filters.

In one embodiment, image sensor 52 includes an area array, such as a charge coupled device (CCD) image sensor or a complementary metal oxide semiconductor (CMOS) image sensor. The area array has a fixed number of horizontal and vertical pixels.

In a CCD image sensor, charge builds up at photosites, which are read one row at a time. CCD image sensors get their name from the way the charge is read from the photosites. To begin, charges on the first row are transferred to a read-out register. From there, the charges are fed to an amplifier and then to an analog-to-digital converter. Once a row has been read, the charges on the read-out register are deleted and charges from the next row enter the read-out register. All rows above the row being read are moved down one row. The charges on each row are “coupled” to those on the row above, such that when one moves down, the next row moves down to fill the vacated space. In this way, each row is read, one row at a time. Functions, such as clock drivers, timing logic, and signal processing are usually not put on the same chip as the photosites. Instead, these functions are put on separate chips, such that systems utilizing CCD image sensors contain a plurality of integrated circuit chips.

CMOS image sensors are created using CMOS technology. CMOS image sensors incorporate other circuits on the same chip, eliminating the need for many separate integrated circuit chips. This allows additional on-chip features to be added at little extra cost. A device using a CMOS image sensor can be smaller, lighter, cheaper, and use less power.

In one embodiment, image sensor 52 is a CCD image sensor and control circuit 54 includes multiple signal processing chips. The CCD image sensor is provided on one integrated circuit chip and control circuit 54 is provided on other integrated circuit chips. The CCD image sensor passes image signals to control circuit 54 to create an image including visual and infrared image portions of cooking station 22. In one embodiment, the CCD image sensor includes filters to receive filtered red, green, blue and infrared electromagnetic waves at the photosites of the CCD image sensor.

In one embodiment, image sensor 52 is a CMOS image sensor. Image sensor 52 and at least part of control circuit 54 are in a single integrated circuit chip. The CMOS image sensor and control circuit 54 create an image including visual and infrared image portions of cooking station 22. In one embodiment, the CMOS image sensor includes filters to receive filtered red, green, blue and infrared electromagnetic waves at the CMOS photosites.

In one embodiment, image sensor 52 includes two image sensors making it sensitive in two spectral regions. One image sensor is sensitive to electromagnetic waves in art of the infrared light spectrum, such as from 8 um to 12 um wavelengths, and the other image sensor is sensitive to electromagnetic waves in the visible and near infrared light spectrum, such as 400 nm to 1100 nm wavelengths. The sensors provide visible and infrared image signals of a cooking station, such as cooking station 22.

In one embodiment, image sensor 52 includes two image sensors, such as one CCD or CMOS image sensor sensitive to electromagnetic waves in the visible and near infrared light spectrum region of 400 nm to 1100 nm wavelengths, and one infrared sensor, such as a platinum scilicide schottky barrier infrared CCD thermal detector sensitive to electromagnetic waves in the infrared light spectrum of 3-5 um wavelengths. The sensors provide visible and infrared image signals of a cooking station, such as cooking station 22.

Control circuit 54 includes a program for processing image signals received from image sensor 52. Control circuit 54 is programmed to distinguish between the different states of cooking station 22. Control circuit 54 processes digital data to distinguish between on and off states of heating areas 26a-26d and oven 28, heating levels of heating areas 26a-26d and oven 28, the presence and absence of pans, people and food, and whether a fire has started.

In one embodiment, control circuit 54 processes digital data to identify that an intermediate level fire has started. In one embodiment, control circuit 54 includes a thermometer, such as a diode thermometer coupled to an analog to digital converter. Control circuit 54 takes temperature readings from the thermometer and combines the temperature reading data with digital image data to identify that an intermediate level fire or a larger fire has started. An intermediate level fire alarm or a fire alarm is set accordingly. In one embodiment, control circuit 54 takes temperature readings from the thermometer to identify a pre-fire condition, such as an over-heated oven or stove.

In one embodiment, control circuit 54 is a microprocessor. In one embodiment, control circuit 54 includes a plurality of signal and image processing, integrated circuit chips that perform a plurality functions. The plurality of functions perform the signal processing needs of monitoring station 20 and include functions, such as clock drivers, timing logic, signal processing and image processing. In other embodiments, control circuit 54 is any suitable signal and image processing circuitry.

Control circuit 54 provides audio signals to speaker 56. Speaker 56 receives the audio signals from control circuit 54 and provides audible alarms. In one embodiment, control circuit 54 provides chirping, tone or buzzer signals to speaker 56, which outputs audible chirps, tones or buzzer alarms. In one embodiment, control circuit 54 includes a voice circuit that provides voice signals to speaker 56, which outputs voice messages. The voice messages indicate the state or combination of states that brought about the alarm and suggested actions to be taken by people in the area. In one embodiment, speaker 56 is a piezo speaker. In one embodiment, speaker 56 is a magnetic speaker. In other embodiments, monitoring system 20 can include one or more lights, such as red lights or strobe lights, activated by control circuit 54 to draw attention to cooking station 22.

Control circuit 54 receives an open/closed state from switch 30. With switch 30 in one state, such as the closed state, control circuit 54 disables monitoring system 20 including the fire alarm. Disabling monitoring system 20 permits open flame cooking. In one embodiment, monitoring system 20 automatically enables itself after a predetermined period of time. In one embodiment, switch 30 is pressed to enable monitoring system 20.

In operation, lens 50 focuses electromagnetic waves from cooking station 22 on to image sensor 52. Image sensor 52 provides image signals of cooking station 22 to control circuit 54. In one embodiment, image sensor 52 collects charges at photosites. The charges are read from the photosites and provided as image signals of cooking station 22 to control circuit 54. Control circuit 54 receives the image signals and processes the image signals to distinguish the different states of cooking station 22. When a state, such as a fire at cooking station 22, or a combination of states trigger an alarm signal, control circuit 54 provides an audible response through speaker 56. In other embodiments described in detail below, the monitoring system communicates with one or more external sources to provide features such as turning off the cooking station and reporting a state and/or combination of states to other people.

FIG. 3 is a diagram illustrating a filter arrangement 80 in one embodiment of image sensor 52. Image sensor 52 includes red filters 82, green filters 84, blue filters 86, and infrared filters 88. Each row 90 includes alternating green filters 84 and red filters 82, and each row 92 includes alternating blue filters 86 and infrared filters 88. Each of the red 82, green 84, blue 86 and infrared filters 88 is placed over one photosite.

Photosites, such as photosites in a CCD image sensor and a CMOS image sensor, without filters placed over them respond to a wide range of electromagnetic wavelengths. To make some photosites sensitive to one portion of the electromagnetic spectrum and other photosites sensitive to another portion of the electromagnetic spectrum, filters are placed over each photosite during manufacturing. Each of the filters, such as each of the red 82, green 84, blue 86 and infrared filters 88 pass certain electromagnetic wavelengths, which strike the photosite below.

Image sensor 52 including filter arrangement 80 provides image signals of cooking station 22 (shown in FIG. 1) in the visual (red, green and blue) light spectrum and the infrared light spectrum. In one embodiment, image sensor 52 including filter arrangement 80 is a CCD image sensor. In one embodiment, image sensor 52 including filter arrangement 80 is a CMOS image sensor.

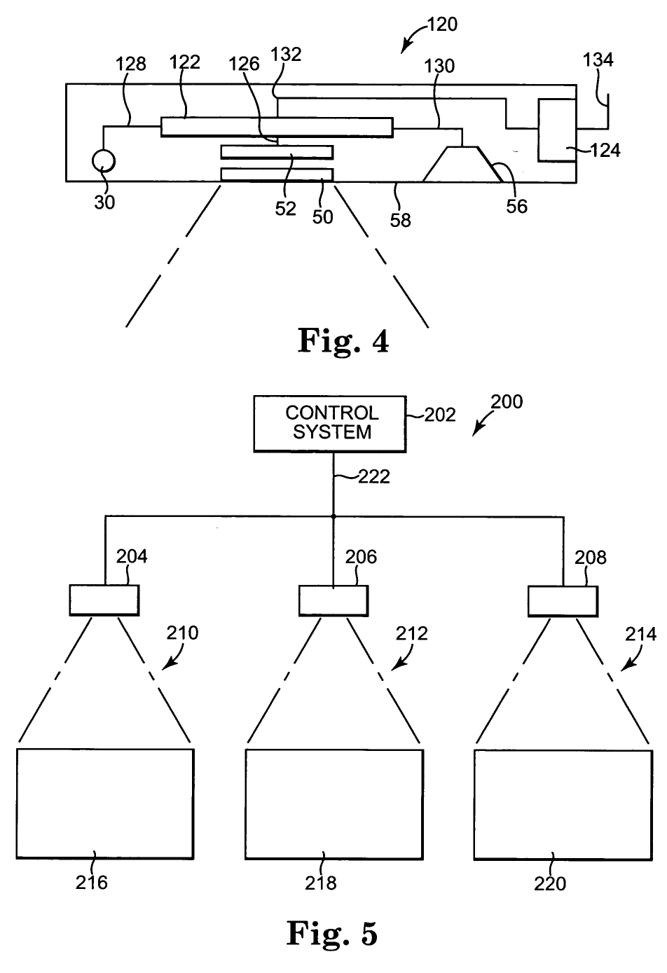

FIG. 4 is a diagram illustrating one embodiment of a monitoring system 120. Monitoring system 120 includes lens 50, image sensor 52, switch 30, speaker 56, enclosure 58, a control circuit 122 and a communications circuit 124. Monitoring system 120 is similar to monitoring system 20, with the addition of communicating with external sources via communications circuit 124.

Image sensor 52 is electrically coupled to control circuit 122 via conductive path 126. Control circuit 122 is electrically coupled to switch 30 via switch conductive path 128, and to speaker 56 via speaker conductive path 130. In addition, control circuit 122 is electrically coupled to communications circuit 124 via conductive path 132.

Lens 50 is mounted to enclosure 58 and positioned to focus electromagnetic waves, such as visible and infrared light, on image sensor 52. Lens 50 focuses the electromagnetic waves from a cooking station, such as cooking station 22 (shown in FIG. 1), on to image sensor 52. Image sensor 52 provides image signals of the viewed cooking station to control circuit 122 via conductive path 126. Image sensor 52 is responsive to electromagnetic waves in the visual and infrared light spectrum.

Control circuit 122 provides audio signals to speaker 56 via speaker conductive path 130. Speaker 56 receives the audio signals from control circuit 122 and provides audible alarms. Control circuit 122 receives an open/closed state from switch 30 via switch conductive path 128. With switch 30 in one state, such as the closed state, control circuit 122 disables monitoring system 20. With switch 30 in the other state, such as the open state, control circuit 122 enables monitoring system 20. Lens 50, image sensor 52, speaker 56 and switch 30 have been previously described in detail herein.

Control circuit 122 is similar to control circuit 54, with the additional ability of communicating with external sources via communications circuit 124. Control circuit 122 includes a program for processing image signals received from image sensor 52. Control circuit 122 is programmed to distinguish between the different states of a cooking station and provide alarm signals based on one state or a combination of states of the cooking station. Control circuit 122 processes digital data to distinguish between on and off states, heating levels, the presence and absence of pans, people and food, and whether a fire has started.

In one embodiment, control circuit 122 processes digital data to identify that an intermediate level fire has started. In one embodiment, control circuit 122 includes a thermometer, such as a diode thermometer coupled to an analog to digital converter. Control circuit 122 takes temperature readings from the thermometer and combines the temperature reading data with digital image data to identify that an intermediate level fire or a larger fire has started. An intermediate level fire alarm or a fire alarm is set accordingly. In one embodiment, control circuit 122 takes temperature readings from the thermometer to identify a pre-fire condition, such as an over-heated oven or stove.

In one embodiment, control circuit 122 is a single microprocessor chip. In one embodiment, control circuit 122 includes a plurality of signal and image processing chips that perform a plurality functions. The plurality of functions perform the signal processing needs of monitoring station 120 and include functions, such as clock drivers, timing logic, signal processing and image processing. In other embodiments, control circuit 122 is any suitable signal and image processing circuitry.

Control circuit 122 communicates with communications circuit 124 via conductive path 132. Communications circuit 124 communicates with external sources via communications path 134. In one embodiment, communications circuit 124 and communications path 134 are configured to communicate via a hard wired connection, such as a dedicated hard wired conductive path between monitoring system 120 and the external source. The dedicated conductive path can include a plurality of conductive lines. In one embodiment, communications circuit 124 and communications path 134 are configured to communicate via a hard wired connection, such as a telephone line. In one embodiment, communications circuit 124 and communications path 134 are configured to communicate wirelessly, such as through an antenna.

Monitoring system 120 communicates with external sources, such as the fire department, the cooking device that is part of the viewed cooking station, the world wide web, a home automation system and a security system. Control circuit 122 communicates via communications circuit 124 with the external sources based on the alarm signal provided by control circuit 122.

In one embodiment, control circuit 122 communicates via communications circuit 124 with the fire department and provides an audible fire alarm via speaker 56 in response to a fire alarm signal. Alerting the fire department brings help quickly to the scene and the audible fire alarm alerts people in the area of the fire.

In one embodiment, control circuit 122 communicates via communications circuit 124 with the cooking device that is part of the viewed cooking station and with the fire department in response to a fire alarm signal. Also, control circuit 122 provides an audible fire alarm via speaker 56 in response to the fire alarm signal. Control circuit 122 communicates with the cooking device to regulate the heating elements of the cooking device. In one embodiment, control circuit 122 turns off all heating elements of the cooking device in response to the fire alarm signal, while alerting the fire department brings help quickly to the scene and the audible fire alarm alerts people in the area of the fire.

In one embodiment, control circuit 122 communicates via communications circuit 124 with the cooking device that is part of the viewed cooking station and provides an audible alarm via speaker 56 in response to the on and unattended alarm signal. Control circuit 122 communicates with the cooking device to regulate the heating elements of the cooking device. In one embodiment, control circuit 122 turns off all heating elements of the cooking device in response to the on and unattended alarm signal to prevent a fire and the audible alarm draws attention to the cooking station.

In one embodiment, control circuit 122 communicates via communications circuit 124 with the cooking device that is part of the viewed cooking station and provides an audible alarm via speaker 56 in response to an alarm signal that indicates the presence of a pan on one of the heating areas of the cooking station, while the heating area is on and unattended. Control circuit 122 communicates with the cooking device to regulate the heating elements of the cooking device. In one embodiment, control circuit 122 turns the heating area to a lower heating level to prevent food from burning and the audible alarm draws attention to the cooking station.

In one embodiment, control circuit 122 communicates via communications circuit 124 with the world wide web to report all alarm signals to a web site. The web site is monitored by someone that responds based on the type of alarm signal.

In one embodiment, control circuit 122 communicates via communications circuit 124 with a home automation system to report all alarm signals to the home automation system. The home automation system responds based on the type of alarm signal transmitted by monitoring system 120. The home automation system can be programmed to alert the fire department, regulate the cooking device that is part of the viewed cooking station and report the alarm signal to a web site on the world wide web. Also, in one embodiment, the home automation system provides audible alarms and other suitable alarms, such as light alarms.

In one embodiment, control circuit 122 communicates via communications circuit 124 with a security system to report all alarm signals to the security system. The security system responds based on the type of alarm signal transmitted by monitoring system 120. The security system can be programmed to alert the fire department, regulate the cooking device that is part of the viewed cooking station and report the alarm signal to a web site on the world wide web. Also, in one embodiment, the security system provides audible alarms and other suitable alarms, such as light alarms.

In one embodiment, the monitoring system does not include switch 30 and speaker 56. Instead, the external source, such as the home automation system and the security system, is configured to disable the monitoring system and provide audible alarm signals. In other embodiments, control circuit 122 can be programmed to communicate via communications circuit 124 to any suitable external source, such as a person with a pager or a cell phone.

In another embodiment of a monitoring system, control circuit 120 is programmed to process image signals received from image sensor 52 to obtain a digital image. The obtained digital image is transferred via communications circuit 124 to an external source. The external source processes the digital image to determine states and combinations of states of the viewed cooking station. Also, the external source provides alarm signals and responses to the alarm signals based on the state or combination of states of the viewed cooking station. The external source can be any suitable source, such as a home automation system or a security system.

FIG. 5 is a diagram illustrating one embodiment of a multiple station monitoring system 200. System 200 includes control system 202, monitoring systems 204, 206, and 208, and cooking stations 210, 212, and 214. Each of the monitoring systems 204, 206, and 208 is similar to monitoring system 120 of FIG. 4. Each of the cooking stations 210, 212, and 214 is similar to cooking station 22 (shown in FIG. 1).

Control system 202 is electrically coupled to each of the monitoring systems 204, 206, and 208 via conductive path 222. Each of the monitoring systems 204, 206, and 208 communicates with control system 202 via conductive path 222. In one embodiment, conductive path 222 is a system bus that is shared by monitoring systems 204, 206, and 208 and control system 202. In one embodiment, conductive path 222 includes one or more conductive lines between each of the monitoring systems 204, 206, and 208 and control system 202.

Monitoring systems 204, 206, and 208 monitor cooking stations 210, 212, and 214. Monitoring system 204 monitors an area, indicated in dashed lines, that includes cooking station 210. Cooking station 210 includes cooking device 216 and the area that is used by a person attending to cooking with cooking device 216. Monitoring system 206 monitors an area, indicated in dashed lines, that includes cooking station 212. Cooking station 212 includes cooking device 218 and the area that is used by a person attending to cooking with cooking device 218. Monitoring system 208 monitors an area, indicated in dashed lines, that includes cooking station 214. Cooking station 214 includes cooking device 220 and the area that is used by a person attending to cooking with cooking device 220. Cooking devices 216, 218, and 220 can be any suitable cooking devices, such as stoves, barbecues, and ovens or combinations of these devices.

Monitoring systems 204, 206, and 208 provide alarm signals to control system 202 to indicate the state or combination of states of one of the cooking stations 210, 212, and 214. Monitoring system 204 provides alarm signals about cooking station 210. Monitoring system 206 provides alarm signals about cooking station 212, and monitoring system 208 provides alarm signals about cooking station 214. Monitoring systems 204, 206, and 208 can be located in the same building or different buildings.

Control system 202 responds to received alarm signals by communicating with external sources, such as the fire department and a web site on the world wide web. In one embodiment, control system 202 is programmed with site locations of monitoring systems 204, 206, and 208 and cooking stations 210, 212, and 214. These site locations are included in the alarm reports to the external sources.

In one embodiment, control system 202 is a home automation system including software to communicate with monitoring systems 204, 206, and 208 and provide responses based on received alarm signals. In one embodiment, control system 202 is a security system including software to communicate with monitoring systems 204, 206, and 208 and provide responses based on received alarm signals.

In one embodiment, control system 202 is electrically coupled to each of the cooking devices 216, 218, and 220. Control system 202 provides responses based on received alarm signals. The responses include turning off one or more cooking devices 216, 218, and 220 and turning down the heating level of heating elements in one or more cooking devices 216, 218, and 220. In one embodiment, control system 202 is programmed to regulate cooking times on cooking devices 216, 218, and 220. Control system 202 regulates the heating level at cooking devices 216, 218, and 220 to complete cooking food items at the same time, such as dinnertime.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A monitoring system, comprising:
an image sensor adapted to provide first image signals of a cooking station based on electromagnetic waves in the visible light spectrum and second image signals of the cooking station based on electromagnetic waves in the infrared light spectrum; and
a control circuit configured to receive the first image signals and the second image signals and process the first image signals and the second image signals to obtain a digital image of the cooking station based on the first image signals and the second image signals and to process the digital image to determine at least one state of the cooking station and provide alarm signals based on the digital image.

2. The monitoring system of claim 1, wherein the at least one state of the cooking station comprises:
one of an on state of the cooking station and an off state of the cooking station.

3. The monitoring system of claim 1, wherein the at least one state of the cooking station comprises:
one of a plurality of heating levels of the cooking station.

4. The monitoring system of claim 1, wherein the at least one state of the cooking station comprises:
one of the cooking station being attended and the cooking station left unattended.

5. The monitoring system of claim 1, wherein the at least one state of the cooking station comprises:
one of the presence of a pan at the cooking station and the absence of a pan at the cooking station.

6. The monitoring system of claim 1, wherein the at least one state of the cooking station comprises:
one of the presence of food in a pan at the cooking station and the absence of food in a pan at the cooking station.

7. The monitoring system of claim 1, wherein the control circuit is configured to provide a signal that indicates the at least one state of the cooking station comprises the combination of an on state of the cooking station and the cooking station left unattended.

8. The monitoring system of claim 1, wherein the control circuit is configured to provide a signal that indicates the at least one state of the cooking station comprises the combination of an off state of the cooking station and the presence of a pan at the cooking station.

9. The monitoring system of claim 1, wherein the control circuit is configured to provide a signal that indicates the at least one state of the cooking station comprises the combination of an on state of the cooking station and one of the presence of a pan at the cooking station and the absence of a pan at the cooking station.

10. The monitoring system of claim 1, wherein the control circuit is configured to provide a signal that indicates the at least one state of the cooking station comprises the combination of the presence of a pan at the cooking station and the cooking station left unattended.

11. The monitoring system of claim 1, wherein the control circuit is configured to provide a signal that indicates the at least one state of the cooking station comprises the combination of an on state of the cooking station, the absence of a pan at the cooking station, and the cooking station left unattended.

12. The monitoring system of claim 1, wherein the control circuit is configured to provide a signal that indicates the at least one state of the cooking station comprises the combination of the presence of a pan at the cooking station, the cooking station left unattended, and one of an on state of the cooking station and an off state of the cooking station.

13. The monitoring system of claim 1, wherein the control circuit is configured to provide a signal that indicates the at least one state of the cooking station comprises a fire has started at the cooking station.

14. The monitoring system of claim 1, wherein the control circuit is configured to provide an intermediate level fire alarm signal that indicates an intermediate level fire.

15. The monitoring system of claim 1, wherein the control circuit comprises a thermometer configured to be read by the control circuit.

16. The monitoring system of claim 1, wherein the control circuit is configured to provide a signal that indicates the at least one state of the cooking station and the signal is adapted to provide at least one of turning off the cooking station, turning the cooking station to a lower heating level, and providing an audible alarm.

17. The monitoring system of claim 1, comprising a communication circuit configured to communicate the alarm signals to least one external source via one of a wired connection and wirelessly, wherein the control circuit is configured to communicate the alarm signals to the at least one external source via the communication circuit.

18. The monitoring system of claim 1, comprising a switch configured to disable the monitoring system and allow cooking via the cooking station with a disabled monitoring system.

19. The monitoring system of claim 1, wherein the control circuit comprises a single chip processor.

20. The monitoring system of claim 1, wherein the control circuit comprises:
a first processor configured to electronically process the first image signals and the second image signals to provide the digital images of the cooking station; and
a second processor configured to electronically process the digital images of the cooking station to determine the at least one state of the cooking station.

21. A system comprising:
a plurality of monitors adapted to monitor a plurality of cooking stations, wherein each of the plurality of monitors is configured to provide at least one signal that indicates at least one state of one of the plurality of cooking stations and each of the plurality of monitors comprises:
an image sensor adapted to provide first image signals of at least one of the plurality of cooking stations based on electromagnetic waves in the visible light spectrum and second image signals of the at least one of the plurality of cooking stations based on electromagnetic waves in the infrared light spectrum; and
a control circuit configured to receive the first image signals and the second image signals and process the first image signals and the second image signals to obtain a digital image of the at least one of the plurality of cooking stations based on the first image signals and the second image signals and to process the digital image to determine the at least one state of the at least one of the plurality of cooking stations based on the digital image; and
a control system configured to receive the at least one signal from each of the plurality of monitors and respond to an external source based on the received at least one signal.

22. The system of claim 21, wherein the control system comprises one of a home automation system and a security system, and the external source comprises at least one of a fire department, a connection to the world wide web, and a cooking device that includes at least one of the plurality of cooking stations.

23. The system of claim 21, wherein the control system is configured to regulate cooking times of the plurality of cooking stations.

24. The system of claim 21, wherein each of the plurality of cooking stations comprise at least one heating area of at least one of a stove, an oven, and a barbecue.

25. A method of monitoring a cooking station, comprising:
transmitting first image signals of the cooking station, which are based on electromagnetic waves in the visible light spectrum;
transmitting second image signals of the cooking station, which are based on electromagnetic waves in the infrared light spectrum;
receiving the first image signals and the second image signals at a control circuit;
processing the first image signals and the second image signals to obtain a digital image of the cooking station based on the first image signals and the second image signals; and
processing the digital image to determine at least one state of the cooking station.

26. The method of claim 25, comprising:
providing alarm signals based on the processed digital image processing the image.

27. The method of claim 26, comprising:
responding to the alarm signals via an audible alarm.

28. The method of claim 26, comprising:
communicating the alarm signals to an external source.

29. The method of claim 26, comprising:
regulating the cooking station in response to the alarm signals.
